(19) United States
(12) Patent Application Publication
(10) Pub. No.: US 2012/0291123 A1
(43) Pub. Date: Nov. 15, 2012

(54) METHOD AND ELECTRONIC DEVICE FOR INPUTTING PASSWORDS

(76) Inventors: Huang Qian, Taipei Hsien (TW); Yang Rui-Yuan, Taipei Hsien (TW); Ma Yue, Taipei Hsien (TW)

(21) Appl. No.: 13/271,767

(22) Filed: Oct. 12, 2011

(30) Foreign Application Priority Data
May 13, 2011 (CN) 201110123567.4

(51) Int. Cl. G06F 21/00; G06F 7/04

(52) U.S. Cl. 726/19

(57) ABSTRACT

A method for inputting passwords is provided. The method includes steps of: displaying a password inputting interface on a screen, wherein the password inputting interface displays a plurality of first objects and a plurality of second objects. The first objects each have different first identification features, such that a user can distinguish the different first objects through the first identification features, and the second objects are at different locations on the screen; receiving at least one of the first objects, followed by the moving of the received at least one first objects to at least one of the second objects, wherein the user operates the movement of the received at least one first objects; and determining if the operation is correct according to moving of the at least one first objects to the at least one second objects.

### BACKGROUND OF THE INVENTION

1. Field of the Invention The present invention relates to methods and electronic devices for inputting passwords, and more particularly, to a method and an electronic device for inputting passwords by moving specific objects to different specific locations.

2. Description of the Prior Art

Due to the ever-increasing concern for personal data security, a verification mechanism plays an important role in protecting various smart terminal devices, such as computers and cell phones, and brings about numerous methods of encryption and decryption, thereby further diversifying verification methods.

A conventional keyboard-based password inputting method usually requires a user to enter preset characters (including numerals or letters of the English alphabet, English letters hereinafter) into a terminal device. The prior art has drawbacks. The conventional keyboard-based password inputting method necessitates operation which is boring and tedious. To render a password safe, a user usually has to memorize a long password composed of characters; as a result, a user in possession of multiple personal passwords is likely to be confounded by the passwords or forget the passwords. Furthermore, the conventional method for inputting passwords involves directly entering into a terminal device a password composed of characters and thus poses a security issue.

For instance, U.S. published patent application US2010/0002878A1 discloses a method for inputting a password by logging in a verification mechanism directly. The method of US2010/0002878A1 involves using a virtual keyboard on a screen and dimming the screen while the password is being inputted. Although the method of US201010002878A1 prevents a furtive glance at the password, it does not lower the chance of a good guess of the password. To enhance password security, a user has to set a long password, at the cost of burdening the user's memory function.

Accordingly, it is imperative to provide a safe and interesting method for inputting passwords to overcome the drawbacks of the prior art.

### SUMMARY OF THE INVENTION

It is a primary objective of the present invention to provide a method and electronic device for inputting passwords by moving specific objects to different specific locations.

Another primary objective of the present invention is to provide a confidentiality-enhanced method for inputting passwords. Using the numerals 0-9 as example, a conventional method for inputting a password involves entering a four-digit password and therefore results in a one in ten thousand chance of successfully guessing the four-digit password. However, in an embodiment of the present invention, given the (six, presumably) positions of second objects, there is a one in six million chance of successfully guessing the four-digit password, assuming that the four digits of the password are four different numerals, respectively.

In order to achieve the above and other objectives, the present invention provides a method for inputting passwords. The method is applicable to an electronic device having a screen. The method comprises the steps of: displaying a password inputting interface on the screen, wherein the password inputting interface displays a plurality of first objects and a plurality of second objects, the first objects each comprising a first identification feature, the first identification features being different, such that the user discerns the plurality of first objects through the first identification features, and the second objects being at different locations on the screen; receiving at least one first object and moving the at least one first object to at least one second object, wherein the moving of at least one first object moved is operated by the user; and determining whether the user is operating correctly according to the moving of the at least one first object to the at least one second object, wherein the above steps achieve the purpose of inputting passwords by determining whether the user is operating correctly.

In an embodiment of the present invention, the positions of the second objects are fixed. If the quantity of the first objects moved by the user is at least two, the method for inputting passwords can further comprise the step of determining whether the user is operating correctly according to the movement sequence of at least two first objects moved.

In order to achieve the above and other objectives, the present invention further provides an electronic device for performing the aforesaid method for inputting passwords. The electronic device comprises a screen and a system for inputting passwords, and the system for inputting passwords enables a user to input passwords, wherein the screen is electrically connected to the system for inputting passwords. The system for inputting passwords comprises: a displaying module for displaying a password inputting interface on the screen, wherein the password inputting interface displays a plurality of first objects and a plurality of second objects, the first objects each comprising a first identification feature, the first identification features being different, such that the user discerns the plurality of first objects through the first identification features, and the second objects being at different locations on the screen; a receiving module for receiving at least one first object after the moving of the at least one first object to at least one second object, wherein the at least one first object is moved by the user; and a determining module for determining whether the user is operating correctly according to the moving of the at least one first object to the at least one second object.

### BRIEF DESCRIPTION OF THE DRAWINGS

The above and other objectives, features, and advantages of the present invention are hereunder illustrated with specific embodiments in conjunction with the accompanying drawings and therefore rendered distinctive and comprehensible, in which:

FIG. 1 is a schematic view of the architecture of an environment in which an electronic device operates according to a specific embodiment of the present invention;

FIG. 2 is a flowchart of a method for inputting passwords according to a specific embodiment of the present invention;

FIG. 3 is a schematic view of a password inputting interface of the method for inputting passwords according to a specific embodiment of the present invention;

FIG. 4 is a schematic view of inputting passwords by the method for inputting passwords according to a specific embodiment of the present invention;

FIG. 5 is a schematic view of correct user's operation by the method for inputting passwords according to a specific embodiment of the present invention;

FIG. 6 is a schematic view of failure of user's operation by the method for inputting passwords according to a specific embodiment of the present invention;

FIG. 7 is a schematic view of a setting interface of the method for inputting passwords according to a specific embodiment of the present invention;

FIG. 8 is a schematic view of setting a password by the method for inputting passwords according to a specific embodiment of the present invention;

FIG. 9 is a schematic view of completion of a setting process by the method for inputting passwords according to a specific embodiment of the present invention;

FIG. 10a is a schematic view of an environment in which a system for inputting passwords operates according to the present invention;

FIG. 10b is a schematic view of the architecture of the system for inputting passwords according to the present invention.

### DETAILED DESCRIPTION OF THE EMBODIMENTS OF THE INVENTION

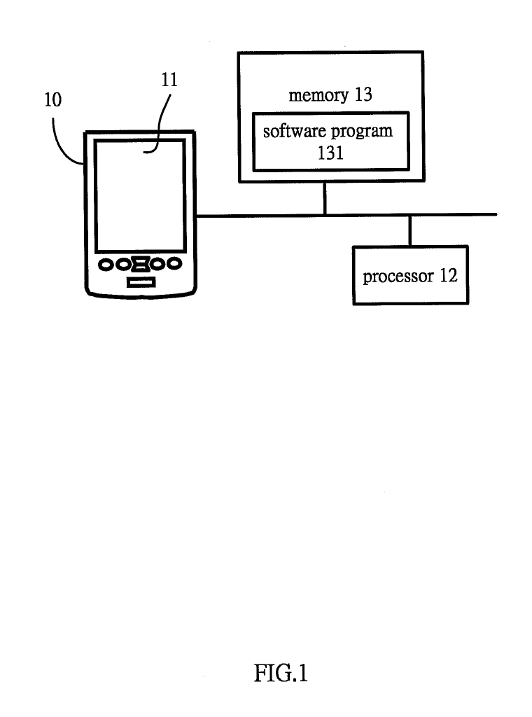

Referring to FIG. 1, there is shown a schematic view of the architecture of an environment in which an electronic device operates according to a specific embodiment of the present invention.

As shown in FIG. 1, in a specific embodiment of the present invention, an electronic device 10 comprises a screen 11, a processor 12, and a memory 13. A system for inputting passwords 5 is effected in the form of a software program 131 stored in the memory 13. The processor 12 is electrically connected to the memory 13, such that the processor 12 is capable of executing the system for inputting passwords 5 to perform a method for inputting passwords of the present invention. In an embodiment of the present invention, the electronic device 10 is preferably a smart phone, though the present invention is not limited thereto. For example, the electronic device of the present invention can also be a PDA, a notebook computer, a tablet computer, or the like.

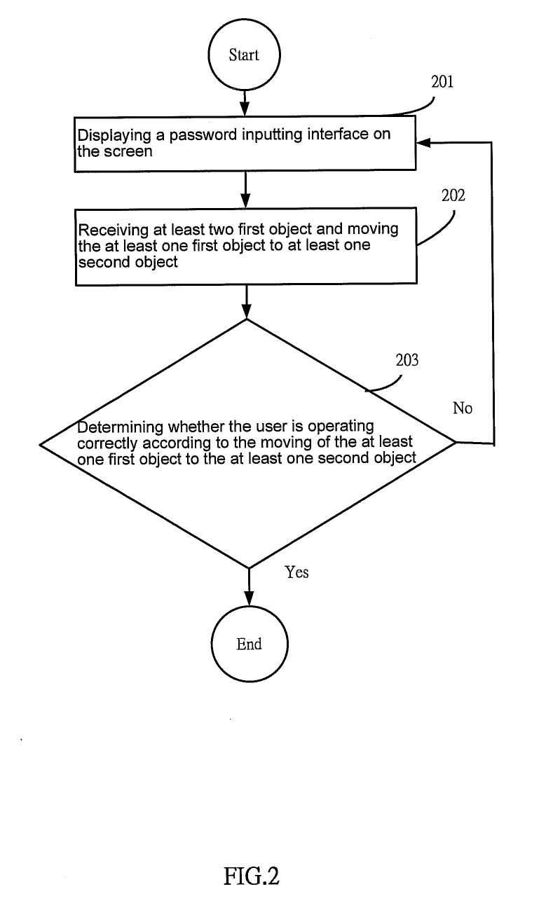

Referring to FIG. 2 through FIG. 6, there is shown in FIG. 2 a flowchart of a method for inputting passwords according to a specific embodiment of the present invention.

Step 201: display a password inputting interface 80 on a screen.

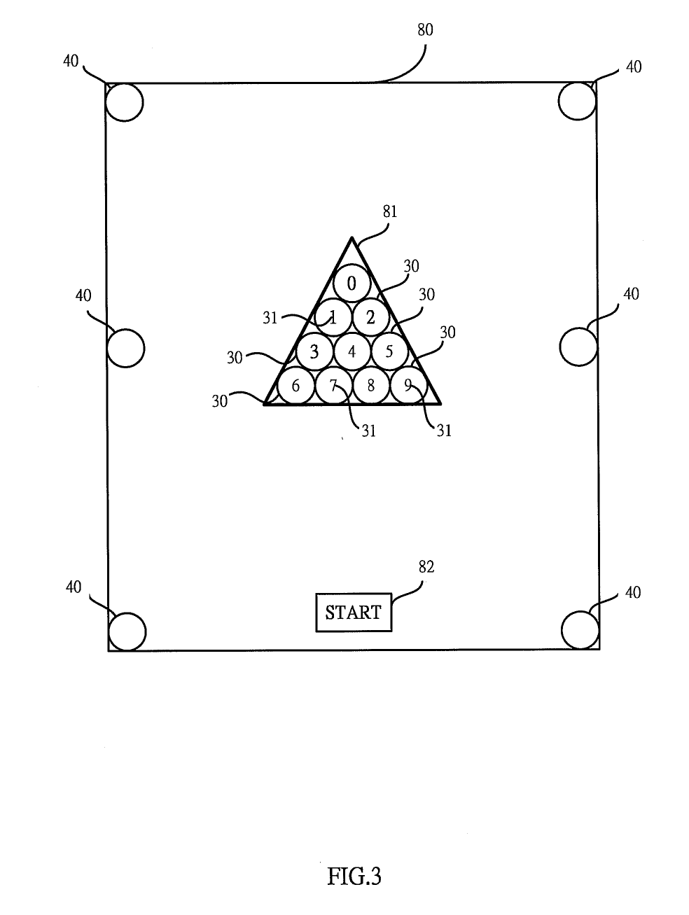

Referring to FIG. 3, the processor 12 of the electronic device 10 can execute the software program 131 in the memory 13 to display the password inputting interface 80 on the screen 11 of the electronic device 10. The password inputting interface 80 displays a plurality of first objects 30 and a plurality of second objects 40. The first objects 30 comprise different first identification features 31. As shown in FIG. 3, in a specific embodiment of the present invention, the password inputting interface 80 takes on an appearance of a billiard table surface, and the first objects 30 are billiard ball-shaped and each have a unique number serving as its first identification feature 31. The second objects 40 are billiard pocket-shaped and are fixed to different locations of the billiard table surface. Prior to the operation of a password inputting process, each of the first objects 30 is fixed to the inside of a triangular ball frame 81. A user can select a start key 82 displayed below the billiard table surface to perform an ensuing operation. A point to note is that, in this embodiment, although the first identification features 31 are denoted by numerals, the first identification features 31 of the present invention are not limited thereto. For example, the first identification features 31 can also be discerned by color, shape, pattern, or any other distinguishable features.

Step 202: receive at least two first objects and move the at least two first objects to at least two second objects.

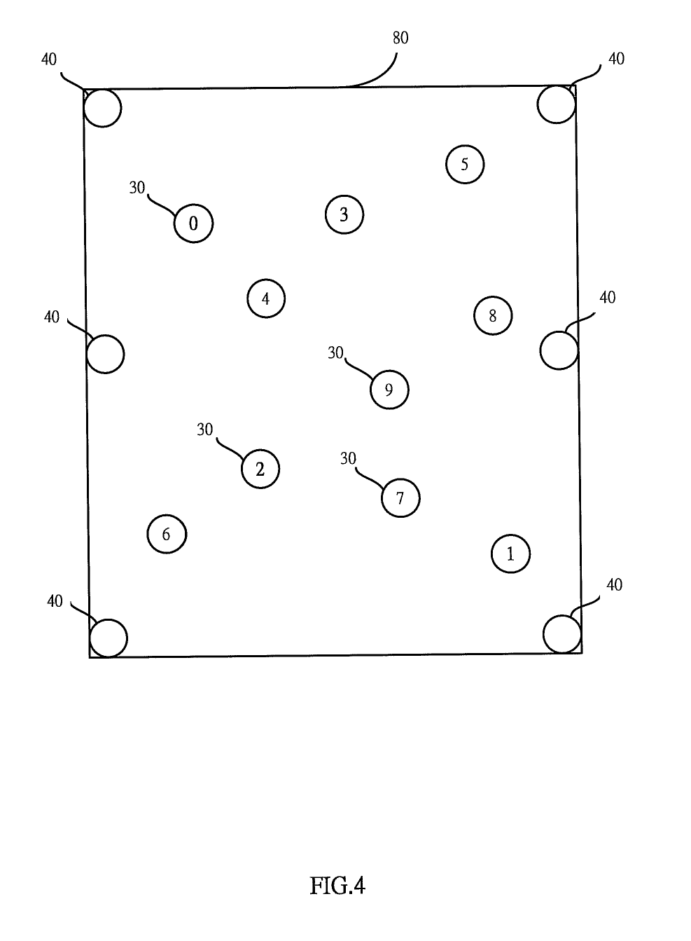

Referring to FIG. 4, after selecting the start key 82, the user can perform the ensuing inputting operation. As shown in FIG. 4, in this embodiment, once the user performs the inputting operation, the first objects 30, which were previously fixed in place at the center of the billiard table surface, will scatter and end up at the corners of the billiard table surface. A point to note is that, in every instance of operating, the points to which the first objects 30 are scattered should be randomly different, so as to prevent unscrupulous persons from prying and memorizing the destinations and eventually stealing passwords.

Afterward, the user can move at least two scattered said first objects 30 to the second objects 40. In a specific embodiment of the present invention, the user moves the first object 30 (numbered 1) to the upper left cornered second object 40, moves the first object 30 (numbered 4) to the upper right cornered second object 40, moves the first object 30 (numbered 0) to the lower left cornered second object 40, and finally moves the first object 30 (numbered 8) to the upper right cornered second object 40. To enhance confidentiality, the more said first objects 30 the user moves, the higher the degree of the resultant confidentiality is. Hence, in a preferred embodiment, the user moves at least two said first objects 30 to at least two different said second objects 40, respectively. The aforesaid quantity of the first objects 30 thus moved is illustrative of a preferred embodiment of the present invention, but the quantity of the characters in a password set by the user should not be limited to at least two. For example, in this embodiment, the user can move a maximum of ten said first objects 30; hence, the user can move the first objects 30 repeatedly to different or identical said second objects 40 so as to enhance the diversity of the combination and alteration of passwords. The screen 11 is a finger-operable touch screen or a non-touch screen (such as one operated by a mouse or separate touchpad).

Step 203: determine whether the user is operating correctly according to the moving of the at least two first objects to the at least two second objects and the movement sequence of the first objects moved.

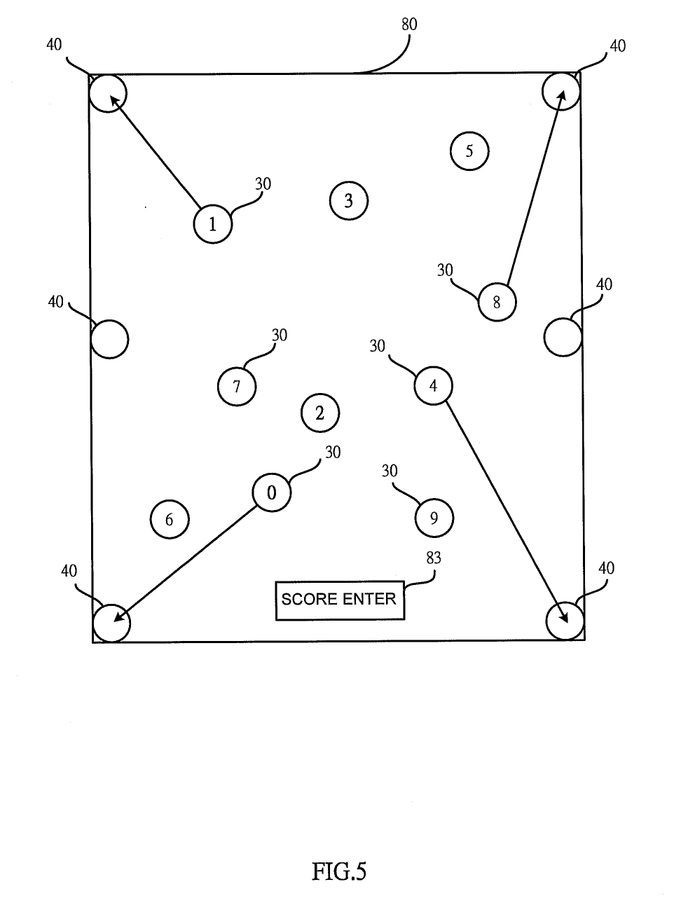

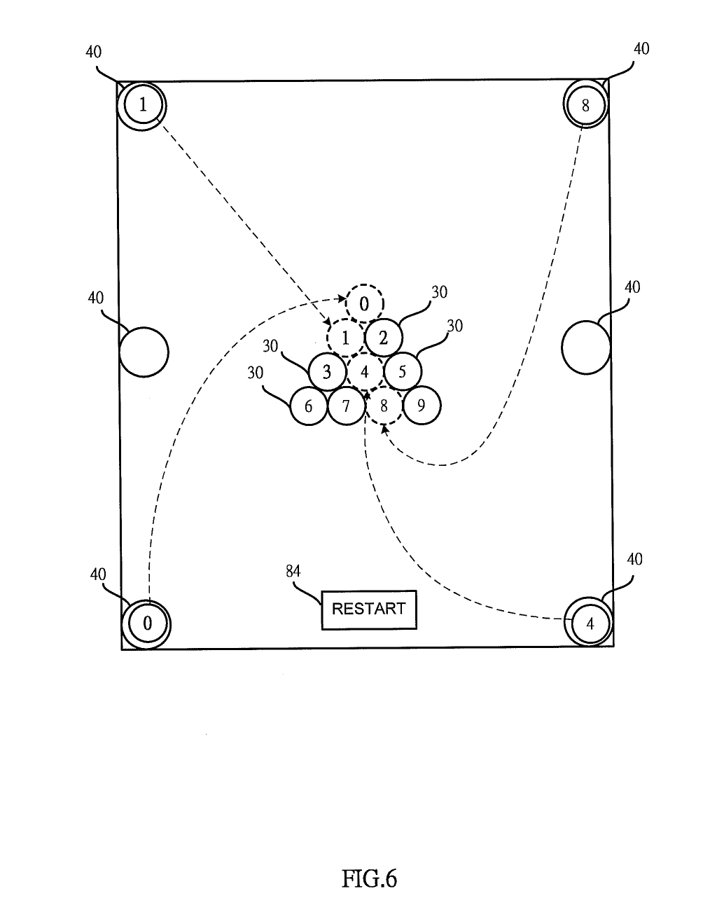

Referring to FIG. 5 and FIG. 6, in a specific embodiment of the present invention, after the user has finished the aforesaid move-in operation, the electronic device 10 starts determining whether the user is operating correctly according to the relationship between the first objects 30 moved and the hosting second objects 40 and the movement sequence of the first objects 30 moved. For example, as shown in FIG. 5, the user moves four said first objects 30, numbered 1, 4, 0, and 8, in sequence, and password-related data required for the electronic device 10 to make a judgment includes “1 upper left 4 lower right 0 lower left 8 upper right”; if a password data entered by the user matches the preset password data, a first prompting key 83 will be displayed below the billiard table surface to display the prompt “score enter”, which means that the user has successfully entered the password data. In contrast, the entry of a password data by the user will be regarded as a failure due to a wrong match if one of the first objects 30 has been moved to a wrong one of the second objects 40, or due to a wrong movement sequence; at the same time, the moved first objects 30 and the remaining unmoved first objects 30 are restored to their initial arrangement (that is, being arranged in a triangular pattern at the center of the billiard table), and a second prompting key 84 is displayed below the billiard table surface to display the prompt “restart” for the user to select (as shown in FIG. 6), such that the user can perform the inputting operation anew. The determining step of the method of the present invention is not limited to the abovementioned; instead, it is feasible to determine whether the user is operating correctly solely according to the moving of the first objects 30 to the second objects 40, for example, moving of the first object 30 numbered 1 to the upper left cornered second object 40, or moving of the first object 30 numbered 7 to the middle left cornered second object 40. The entry of a password data by the user will be regarded as a success, provided that the moved first objects 30 and the hosting second objects 40 match the ones preset by the user. To facilitate recordation and reading, it is feasible to number each of the second objects 40 (with English letters, for example).

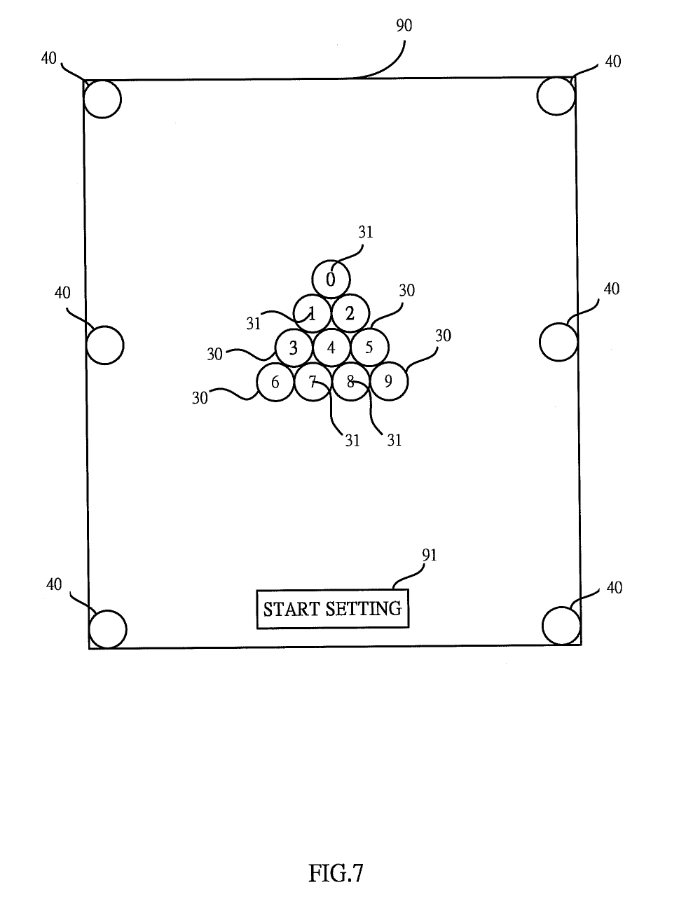

Referring to FIG. 7 through FIG. 9, there are shown in the drawings schematic views of password setting.

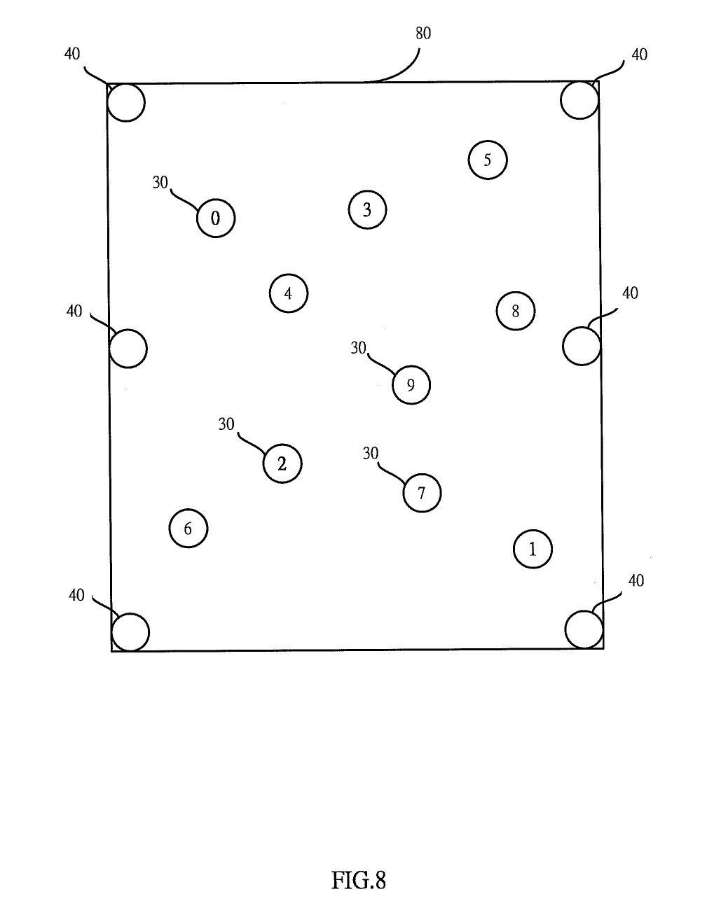

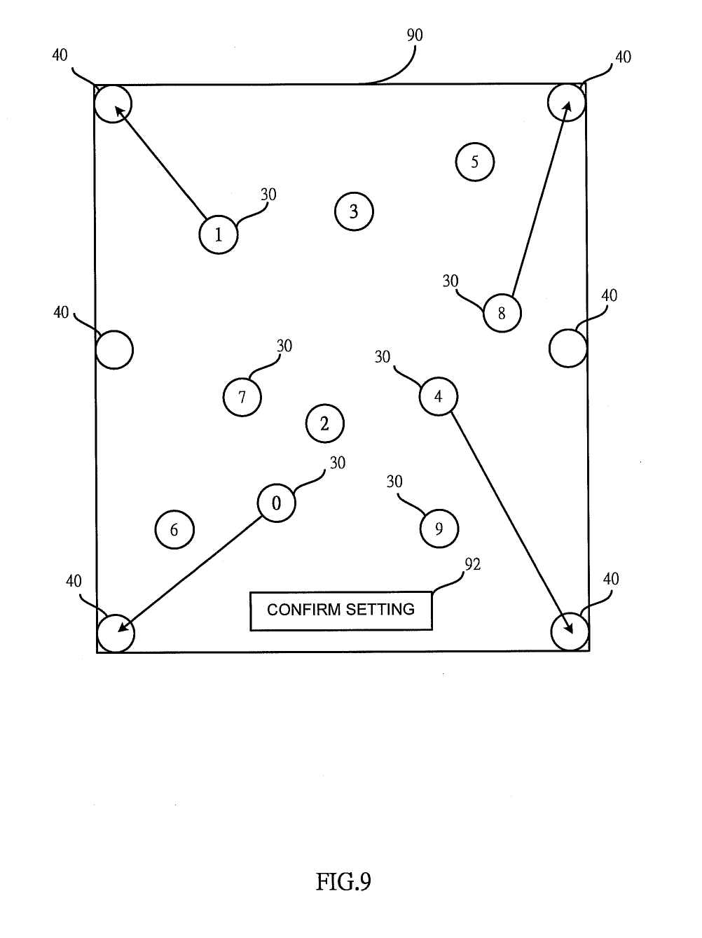

As shown in FIG. 7, in a specific embodiment of the present invention, to perform the method for inputting passwords, the user can either set a password in advance or change an existing password. Before the setting process begins, the screen 11 displays a setting interface 90 for displaying the plurality of first objects 30 having different said first identification features 31, and the plurality of second objects 40; their quantity and the first identification features 31 are the same as the first objects 30 and the second objects 40 of the password inputting interface 80. In a specific embodiment of the present invention, the setting interface 90 is preferably designed to take on the same appearance of a billiard table surface as the password inputting interface 80 has. A setting key 91 is displayed below the billiard table surface. Once the user selects the setting key 91, the first objects 30, which were previously arranged neatly will scatter randomly (as shown in FIG. 8). Then the user can move the first objects 30 to the second objects 40 for setting passwords. For example, the user moves the first object 30 (numbered 1) to the second object 40 in the upper left corner, moves the first object 30 (numbered 4) to the second object 40 in the lower right corner; meanwhile, the memory 13 of the electronic device 10 accesses the first objects 30 moved by the user, the hosting second objects 40, and the sequence in which the first objects 30 are moved. Also, the processor 12 of the electronic device 10 displays a setting confirmation key 92 (as shown in FIG. 9) below the billiard table surface for the user to select. However, at this point in time, the user can still continue to move other said first objects 30 to the second objects 40 repeatedly unless and until the setting of intended passwords is completed and confirmed. Then the user selects the setting confirmation key 92 to finalize the setting of passwords. Afterward, for example, the user moves the first object 30 (numbered 0) to the second object 40 in the lower left corner, moves the first object 30 (numbered 8) to the second object 40 in the upper right corner, and finally selects the setting confirmation key 92 again to finalize the password setting step. The aforesaid preferred embodiments are illustrative of the method of the present invention, but the present invention is not limited thereto. For example, the password setting step of the method of the present invention may start with determining a sequence of moving the first objects 30 to the second objects 40 according to the determined sequence to finalize the password setting step. Although the method for inputting passwords is effected by the execution of a software program, the present invention is not limited thereto.

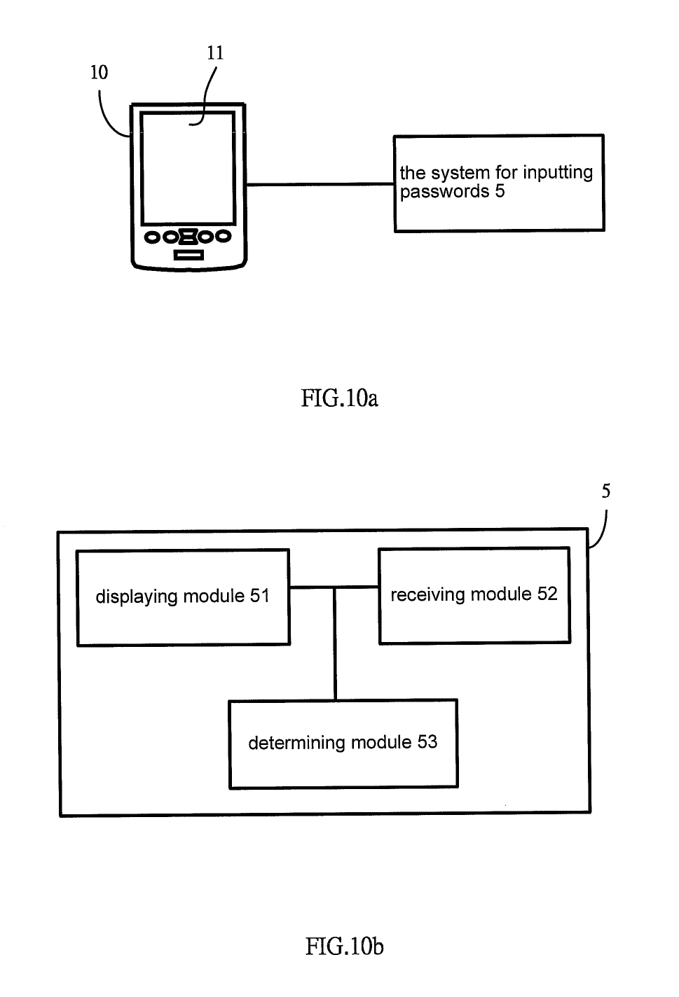

Referring to FIG. 10a and FIG. 10b, there is shown in FIG. 10a a schematic view of an environment in which a system for inputting passwords operates according to the present invention, and there is shown in FIG. 10b a schematic view of the architecture of the system for inputting passwords according to the present invention.

The system for inputting passwords 5 of the present invention is applicable to the electronic device 10 having a screen 11. The system for inputting passwords 5 comprises a displaying module 51, a receiving module 52, and a determining module 53.

The displaying module 51 displays the password inputting interface 80 on the screen (the aforesaid step 201). The receiving module 52 receives at least two first objects and moves the at least two first objects to at least two second objects (the aforesaid step 202). The determining module 53 determines whether the user is operating correctly according to the moving of the at least two first objects to the at least two second objects and the movement sequence of the first objects moved (the aforesaid step 203). A point to note is that, in addition to hardware devices, software programs (as disclosed in the aforesaid embodiments), firmware, or a combination thereof, the aforesaid modules can be implemented in the form of circuit loops or any other appropriate forms. Furthermore, this embodiment is intended to be illustrative of a preferred embodiment of the present invention, and thus details of all possible variations and combinations are omitted from the description of this embodiment for the sake of brevity.

In conclusion, the features of the present invention are completely different from those of the prior art in terms of objectives, means, and effects. However, it should be noted that the above embodiments are illustrative of the principle and effect of the present invention only, and should not be interpreted as restrictive of the scope of the present invention. Hence, persons skilled in the art can make modifications and changes to the aforesaid embodiments without violating the technical principle and spirit of the present invention. Accordingly, the extent of legal protection for the rights claimable toward the present invention should be defined by the appended claims.

What is claimed is:

1. A method for inputting passwords, the method being applicable to an electronic device having a screen for allowing a user to input the passwords, the method comprising the steps of:
displaying a password inputting interface on the screen, wherein the password inputting interface displays a plurality of first objects and a plurality of second objects, the first objects each comprising a first identification feature, the first identification features being different, such that the user discerns the plurality of first objects through the first identification features, and the second objects being at different locations on the screen;
receiving at least one first object, followed by the moving of the at least one first object to at least one said second object, wherein the at least one first object is moved by the user; and
determining whether the user is operating correctly according to the moving of the at least one first object to the at least one second object,
wherein the above steps achieve the purpose of inputting passwords by determining whether the user is operating correctly.

2. The method of claim 1, wherein positions of the second objects are fixed.

3. The method of claim 2, wherein the first objects are billiard ball-shaped, and the second objects are billiard pocket-shaped.

4. The method of claim 3, wherein a quantity of the at least one first object moved is at least two.

5. The method of claim 4, further comprising determining whether the user is operating correctly according to a movement sequence of the at least two first objects moved.

6. The method of claim 5, wherein the first identification features are characters.

7. The method of claim 1, wherein a quantity of the at least one first objects moved is at least two.

8. The method of claim 7, further comprising determining whether the user is operating correctly according to a movement sequence of the at least two first objects moved.

9. An electronic device comprising a screen and a system for inputting passwords, the screen being electrically connected to the system for inputting passwords, wherein the system for inputting passwords enables a user to input passwords and comprises:
a displaying module for displaying a password inputting interface on the screen, wherein the password inputting interface displays a plurality of first objects and a plurality of second objects, the first objects each comprising a first identification feature, the first identification features being different, such that the user discerns the plurality of first objects through the first identification features, and the second objects being at different locations on the screen;
a receiving module for receiving at least one first object and moving the at least one first object to at least one second object, wherein the at least one first object moved is operating by the user; and
a determining module for determining whether the user is operating correctly according to moving of the at least one first object to the at least one second object.

10. The electronic device of claim 9, wherein positions of the second objects are fixed.

11. The electronic device of claim 10, wherein the first objects are billiard ball-shaped, and the second objects are billiard pocket-shaped.

12. The electronic device of claim 11, wherein a quantity of the at least one first objects moved is at least two.

13. The electronic device of claim 12, wherein the determining module determines whether the user is operating correctly according to a movement sequence of the at least two first objects moved.

14. The electronic device of claim 13, wherein the first identification features are characters.

15. The electronic device of claim 9, wherein a quantity of the at least one first objects moved is at least two.

16. The electronic device of claim 15, wherein the determining module determines whether the user is operating correctly according to a movement sequence of the at least two first objects moved.
